(19) United States
(12) Patent Application Publication
(10) Pub. No.: US 2026/0335769 A1
(43) Pub. Date: Oct. 29, 2026

(54) GAMEPLAY CONTEXT-AWARE AGENT FOR TESTING A VIDEO GAME

(71) Applicant: SONY INTERACTIVE ENTERTAINMENT INC., Tokyo (JP)

(72) Inventors: Matthew McCallum, Wildomar, CA (US); Christian Rickeby, Trabuco Canyon, CA (US); Richard S. Martin, Laguna Hills, CA (US); Erick Flores, Aliso Viejo, CA (US)

(21) Appl. No.: 19/192,940

(22) Filed: Apr. 29, 2025

(51) Int. Cl. A63F 13/63; A63F 13/537

(52) U.S. Cl. CPC A63F 13/63; A63F 13/537

(57) ABSTRACT

Techniques for described for a context-aware for game testing. An example method can include processing video game information from a first gameplay session of a video game application. The method can further include determining video information from an image frame displayed during the first gameplay session of the video game application based on processing the video game information. The method can further include determining context information from the image frame displayed during the first gameplay session, the context information to be used by an artificial intelligence (AI) agent during a second gameplay session of the video game application. The method can further include transmitting, via an application programming interface (API), the context information to the AI agent.

### BACKGROUND

Video game debugging can be a process of identifying, analyzing, and resolving errors or glitches in a video game code to ensure that the video game functions as intended. Debugging can include examining gameplay behavior, code performance, and player interactions to pinpoint issues and implement fixes for an enjoyable gamer experience.

### BRIEF SUMMARY

The embodiments described herein describe techniques for collecting video game information during the gameplay of a video game application and to determine context for an artificial intelligence agent configured to play the video game application. The video game information can include image information (e.g., image frames), audio information (e.g., audio files), and controller information (e.g., controller inputs, haptic information from a haptic enabled controller).

A cloud computing system can be configured to detect a cloud-based session of a video game application. The cloud computing system can further be configured to access the controller information received at a cloud-based gaming server and the audio and image information that is generated based on the controller information. The cloud computing system can access the information such that the information is also transmitted to the player's gaming console in real time, such that the player does not experience any diminishment in the gameplay experience. The collected information can be used to for various tasks, such as debugging and gameplay enhancement.

The cloud computing system can further be configured to determine context information in the video game application. The context information can include, for example, a setting, a mini-boss, a boss, an item loadout or other context information. By collecting video game application that includes context information, the computing system can collect information that provides context information to be used by an AI agent, such as for game debugging and game enhancement.

### BRIEF DESCRIPTION OF THE DRAWINGS

FIG. 1 is an illustration of an example computer system that presents a dashboard, according to one or more embodiments.

FIG. 2 is an illustration of an example system for gameplay data collection, according to one or more embodiments.

FIG. 3 is an illustration of an example signaling diagram for gameplay data collection, according to one or more embodiments.

FIG. 4 is an example matrix, according to one or more embodiments.

FIG. 5. is an illustration of an example system for using gameplay data by an artificial intelligence (AI) agent, according to one or more embodiments.

FIG. 6 is an illustration of an example video information from gameplay, according to one or more embodiments.

FIG. 7 is an illustration of an example audio information from gameplay, according to one or more embodiments.

FIG. 8 is an illustration of controller information from gameplay, according to one or more embodiments.

FIG. 9 is an example process for video game information collection, according to one or more embodiments.

FIG. 10 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the video game industry, ensuring the quality of a game before its release is critical to delivering a seamless and engaging player experience. Traditional quality assurance (QA) methods, which rely heavily on human testers, can be time-consuming, resource-intensive, and limited in scope when addressing the vast complexity of modern video games. To address these challenges, an artificial intelligence (AI) agent can be used as a tool for automating and enhancing the QA process. By leveraging advanced algorithms and machine learning techniques, the AI agent can systematically play through a video game, analyzing gameplay mechanics, detecting bugs, and identifying inconsistencies across diverse scenarios. The AI agent can enable comprehensive testing at a scale and speed unattainable by human testers, and provide actionable insights to developers, ensuring that the game meets high standards of performance, functionality, and player satisfaction.

Embodiments of the present invention can provide a computing system that can acquire and process video game information generated during a first gameplay session of a video game application. The gameplay can be based on a human user playing the video game application or an artificial intelligence (AI) agent playing the video game application. The video game information can be acquired from live gameplay or recorded video game information. This video game information, which may include video information, audio information, controller information, metadata, and other information, is analyzed to determine contextual video information from an image, and an audio file, or controller inputs during the gameplay session. The computing system can use image processing techniques to identify contextual details from visual elements in the video game images. The computing system can use audio processing techniques to identify contextual details from audio elements in the audio file. The computing system can use data processing to identify context information from the controller information received from controller inputs. These contextual details may include object positions, player interactions, or environmental elements that are critical for understanding the gameplay scenario.

After the computing system has determined the context information from the video information, audio information, and controller information, the computing system can prepare the information for transmission to the AI agent via an application programming interface (API). For example, the context information can be structured to provide the AI agent with a comprehensive understanding of the gameplay scenario, enabling it to perform tasks such as strategic decision-making, adaptive gameplay assistance, or predictive modeling for future game states. The API can ensure communication between the computing system and the AI agent, facilitating the delivery of actionable insights derived from the gameplay session. Providing this context information can enable the AI agent to successfully engage in a gameplay session. This gameplay session can be used for testing the video game application allowing it to enhance the gaming experience by adapting to the player's needs and the evolving game environment.

The AI agent can process the received data and engage in a gameplay session of the video game application. Based on the gameplay, the AI agent can generate feedback based on its performance or decision-making during this gameplay session. This feedback can be transmitted back to the computing system, where it is analyzed to identify areas of improvement or additional data requirements. For example, the computing system can determine other video, audio, or controller elements to identify. Or the computing system can determine other context information to provide to the AI agent. The computing system can dynamically incorporate the feedback to determine new or refined information to provide to the AI agent in subsequent iterations. This iterative feedback loop ensures that the AI agent continually learns and adapts to the gameplay environment, improving its performance over time. The integration of feedback into the process not only enhances the accuracy and relevance of the information provided to the AI agent but also ensures a more engaging and also a responsive gaming experience for a player engaging in gameplay of the video game application.

Conventional system for video game testing can face various challenges. For example, video game applications can generate vast amounts of information during gameplay, including images, audio streams, controller information, and metadata. Processing this raw video game information to efficiently extract specific video information and contextual data from an image displayed during a gameplay session can be a time-consuming and resource intensive process. Another challenge can be that an AI agent can require context-specific information to provide meaningful and adaptive assistance during gameplay sessions. Another challenge exists in determining and transmitting precise context information derived from images displayed during a first gameplay session to the AI agent. Another challenge can be that after context information is transmitted to an AI, utilizing feedback from the AI agent to refine the information provided to it can be difficult as the process may need to account for dynamically incorporating the feedback into subsequent analyses, determining new information for the AI agent, and ensuring the system iteratively improves its understanding of the video game environment.

The embodiments herein address the above-referenced challenges. The herein described computing system can process raw video game information generated during gameplay by using techniques to extract video information and generate context information from images in real-time or near real-time, thereby reducing the time and resource intensity of conventional methods. Additionally, the techniques described herein can enable an AI agent to receive video game application specific context information derived from images, audio files, and controller input generated during a gameplay session. Furthermore, the integration of feedback from the AI agent can address the complexity of refining and improving the context information provided to the AI agent. By dynamically incorporating feedback into subsequent analyses, the computing system can iteratively improve the AI agent's understanding of the video game environment, ultimately enhancing the accuracy, efficiency, and scalability of the QA process. By improving the QA process, the techniques herein can improve the quality of video game applications, include a code base, graphics, and audio of the video game application.

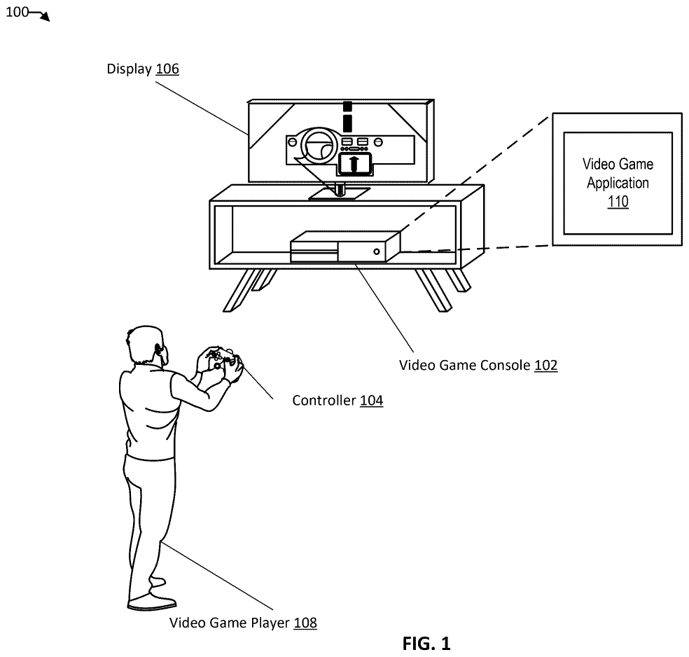

FIG. 1 is an illustration 100 of an example computer system that presents a dashboard, according to an embodiment of the present disclosure. As illustrated, the computer system includes a video game console 102, a video game controller 104, and a display 106. Although not shown, the computer system may also include a backend system, such as a set of cloud servers, that is communicatively coupled with the video game console 102. The video game console 102 is communicatively coupled with the video game controller 104 (e.g., over a wireless network) and with the display 106 (e.g., over a communications bus). A video game player 108 operates the video game controller 104 to interact with the video game console 102. These interactions may include playing a video game presented on the display 106, interacting with a menu presented on the display 106, and interacting with other applications of the video game console 102 (e.g., with media applications to stream media from an online content source or to play a media file from the local storage of the video game console 102).

The video game console 102 includes a processor and a memory (e.g., a non-transitory computer-readable storage medium) storing computer-readable instructions that can be executed by the processor and that, upon execution by the processor, cause the video game console 102 to perform operations related to various applications. In particular, the computer-readable instructions can correspond to program codes for the various applications of the video game console 102 including video game application 110, video game application 112, controller application 114, and audio application 116. A video game application, such as video game application 112, generally represents a computer application executable to present video game content, receive user interaction with the video game content, and accordingly update the video game content. The availability of a video game application, and/or other type of computer application to the video game player 108 via the video game console 102 can depend on a user identifier of the video game player 108 (e.g., upon a login to the video game console 102, the availability of the computer applications can depend on the user identifier used in the login).

The video game application 110 can present image information, such as the visual frames of the video application. In response to an interaction with a video game controller 104, the video game application 110 can display a movement in the video game application that corresponds to the interaction. For example, if the video game controller 104 is interacted with to indicate forward motion, the video game application can cause an image of a character to appear to move forward. The video game application can further present audio corresponding to the video game application. The audio information can include, for example, music presented during game play,

The video game controller 104 is an example of an input device. The video game controller 104 may allow the video game player 108 to interact with one or more GUIs presented by the video game console 102 on the display 106. For example, using one or more directional control inputs (e.g., a joystick and/or a directional pad) the user can navigate to and within various menus, dashboards, and UI elements. The interaction with the video game controller 104 can be converted into electrical signals and transmitted to a cloud server as controller information. Other types of the input device are possible including, a keyboard, a touchscreen, a touchpad, a mouse, an optical system, a microphone, a camera, or other user devices suitable for receiving input of a user. For example, a microphone may allow the video game player 108 to interact with the GUIs using various voice commands. As another example, a camera may allow the video game player 108 to interact with the GUIs using various gesture commands.

Upon an execution of the video game application 110 by the video game console 102, a rendering process of the video game console 102 presents video game content (e.g., illustrated as a car race video game content) on the display 106. Upon user input from the video game controller 104 (e.g., a user push of a particular key or button), the rendering process also presents the menu. Additionally, or alternatively, the menu may be presented as an initial landing page in response to a user powering-on the video game console 102 and/or waking the video game console 102 from a suspended state. Depending on the user input, the menu corresponds to the home UI page, a landing page, or the like. The menu can be presented in a layer over the video game content.

Although FIG. 1 illustrates that the different applications are executed on the video game console 102, the embodiments of the present disclosure are not limited as such. Instead, the applications can be executed on the backend system (e.g., the cloud servers) and/or their execution can be distributed between the video game console 102 and the backend system.

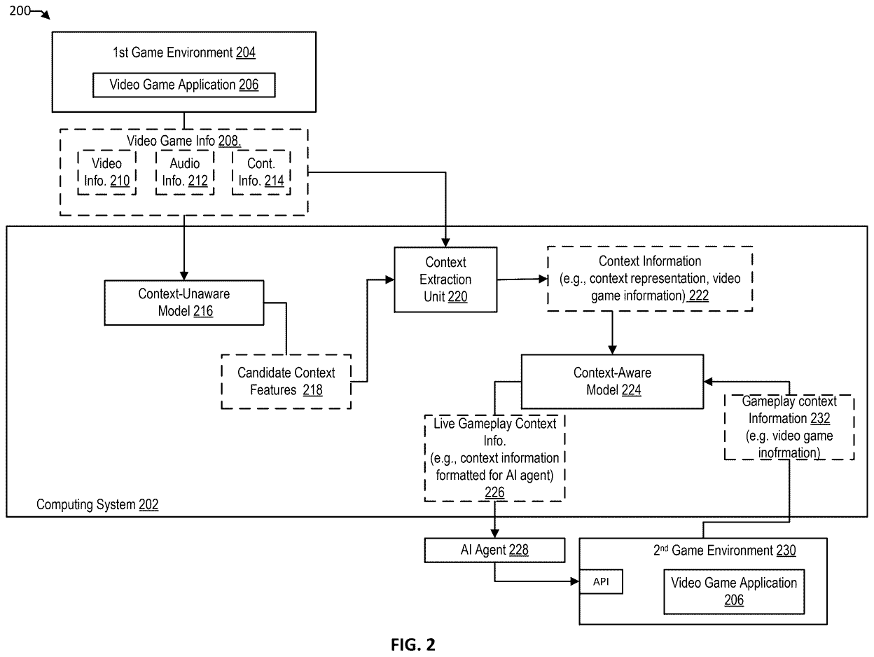

FIG. 2 is an illustration 200 of an example system for gameplay data collection, according to one or more embodiments. A first game environment 204 can be established for gameplay of a video game application 206 (e.g., Horizon Zero Dawn, God of War, or other video game application. The first game environment 204 can include a server, such as a server for a cloud-computing environment. The server can be a gaming server for permitting one or more users to engage with the video game application. For example, the server can permit multiple users to engage in a cloud-based video game application. In some embodiments, the server can permit an AI agent to engage in gameplay of the video game application 206.

The computing system 202 can interface with the first game environment (204), during a gameplay session of the video game application 206 or after completion of the gameplay session. During the gameplay session, the video game application 206 can generate video game information 208, such as video information 210 (e.g., image frames), audio information 212 (e.g., audio files), and controller information 214 (controller inputs). As indicated above, in some instances, the gameplay is performed by an AI agent. In these instances, the controller information can be in the form of application programming interface (API) requests made by the AI agent to control the gameplay (e.g., causing a character to move in a direction, use an item, engage in dialogue, or other gameplay).

This video game information can be received by the computing system 202. In some embodiments, the computing system 202 can include a video game information unit that is operable to identify different information types in the video game information. For example, the video game information unit can identify video information, such as image frames, audio information such as an audio file, and controller information, such as controller inputs. The video game information unit can separate the video game information by type and transmit the different types of information in different streams to a context-unaware model 216.

The context-unaware model 216 can be a multi-modal machine learning model (e.g., transformer, neural network, or other model architecture). A multi-modal model can be a model that can process different types of video game information. For example, the context-unaware model 216 can process image information, audio information, and textual information or electrical information. For example, the controller information may be in the form of textual information or electrical signaling information. Each information type can be processed based on the type. For example, image information can be converted to a set of numerical matrices. The audio information can be converted into spectrograms or feature vectors. Textual information can be tokenized into numerical representations. Signaling information can be converted into a numerical representation. The context-unaware model 216 can process each piece of converted information to extract features from the information. As the features are extracted from information of different types (e.g., modalities), the context-unaware model 216 can project the features onto a shared vector space.

The context-unaware model 216 can then determine relationships between the features that are projected onto the shared vector space. The context-unaware model 216 can be context-unaware, such that it can predict relationships without training on the relationships between the inputted information as to context. In other words, the context-unaware model 216 may not consider prior relationships between the various extracted features for predicting context information.

The context-unaware model 216 can generate an output that includes candidate context features 218. For example, the context-unaware model 216 can process the different types of video game information and identify candidate context features 218 without being trained on higher-order relationships and output video game features that may be useful for determining context. In some embodiments, the context-unaware model can act as a feature extractor that can transform the higher dimension video game information 208 into a lower dimension representation of the video information 210, the audio information 212 and the controller information 214. The features extracted by the context-unaware model 216 can identify relationships between the video information 210, the audio information 212 and the controller information 214. The context-unaware model 216 is untrained on context information from a video game, it can identify relationships that are not influenced by context information training and may be more generalized relationships. The generalized features can assist a context-aware model to identify more specific features for determining context. The generalized features can also assist with continuously training a context-aware model to focus on more complex relationships between features. Additionally, as the context-unaware model 216 relies on weights that have not been optimized by context information feature extraction, the generalized features can assist a context-aware model to consider alternative features and relationships from that with which it has been trained. The candidate context features 218 can be transmitted to a context extraction unit 220.

The video game information 208 can also be passed to a context extraction unit 220, that can be a machine learning model (e.g., transformer, neural network, or other model architecture) for extracting for extracting specific context features. These features may include representations of in-game objects, player interactions, environmental details, and relationships between these elements, forming a granular understanding of the game environment.

For example, the context-unaware model 216 can process video information (e.g., frames) and identify features that represent characters, objects and an environment. for example, the context-unaware model 216 may or may not understand the difference between a player and an NPC, the difference between a main-boss and a player or mini-boss. The context-unaware model 216 may identify a feature representative an object, such as a health container, but may not understand the significance of the object. The context-unaware model 216 can process an audio file and identify features representing different voices and dialog, but may not understand the significance of the characters or dialog. The context-unaware model 216 may determine the relationships between the image features that represent a character, a speech attributed to the character, and a controller input (from controller information) that caused the speech. However, the context-unaware model 216 may not understand the significance of the character (e.g., NPC, player, hero, villain or other character) or how the character and speech influence the overall gameplay.

The video game information 208 can also be also passed to a context extraction unit 220, that can be a machine learning model that is trained for extracting for extracting specific context features. These features may include representations of in-game objects, player interactions, environmental details, and relationships between these elements, forming a context information used for understanding of the video game application. The context extracting unit 220 can further determine context information from the candidate context features 218, and the video game information 208. Returning to the above example, the context-unaware model 216 may have extracted features that represent different characters. The context extraction unit 220 can extract additional features that may further identify features that provide information that may influence gameplay. For example, the context extraction unit 220 can extract features from the video information 210 that identify context, such as the character's role (e.g., NPC, player, hero, villain or other character) in the gameplay. Furthermore, the context extraction unit 220 can extract features from the audio information 212 that identifies a gameplay significance, such as whether dialog relates to a mission, is a question of morality, or could lead to a game event like a fight or romance. Furthermore, the context extraction unit 220 can extract features from the controller information 214 that indicate that the controller input influenced some gameplay. For example, a controller input may indicate a choice that foregoes a questline or options during gameplay.

The context extraction unit 220 can output context information 222 that can include a contextual representation, such as a vector or a matrix of the context. The context information can also include the video game information 208. As used herein, context information can include information that can be used to influence gameplay decisions. For example, the context information can include game state information, such as health, stamina, mana or other character attributes. The game state information can include the location of one or more characters in the video game application. The game state information can include a character's item inventory. The game state information can further include character skill level and abilities. The context information can also include non-player character (NPC) information. For example, the NPC information can include NPC attributes information, NPC relationship status with player. The NPC information can also include NPC location relative to a player. The context information can also include temporal information. The temporal information can include past decisions that influence current states, such as choice of faction, question completions, morality decisions. The temporal decisions can also include an order of events or missions accepted. The temporal events can also include lengths of time, such a length of time in an area, cooldown time, powerup time. The context information can also include spatial information, such as player and NPC positions, explored areas and unexplored areas, and area in field of view. The context information can include narrative context, such as story or mission progression The context information can also include NPC behavior, such as how NPC adjust behavior based on player actions. The context information can include other information that can influence gameplay decision making.

The context-aware model 224 can be a machine learning model (e.g., transformer, neural network, or other model architecture) that is trained for understanding how context information can influence gameplay. The context-aware model 224 can further be trained to provide live gameplay context information 226 to an AI agent 228 during gameplay.

The AI agent 228 can be a machine learning model (e.g., transformer, neural network, or other model architecture) trained to play a video game application 206. For example, a second game environment 230 can be created to permit the AI 228 to play the video game application 206. The AI agent 228 can make API calls to the second game environment 230 to control the video game application. For example, the API calls can be instructions for controllers player, selecting a dialog option, selecting an item from inventory, or other video game application choice. As the AI agent 228 is engaging in gameplay for the video game application, the second game environment 230 can provide gameplay context information 232 to the context-aware model. The gameplay context information 232 can include, for example, video information, audio information, API call information. The gameplay context information 232 can also include state information (e.g., player alive, player dead, or other state information). The context-aware model 224 can process the gameplay context information 232 and determine which live gameplay context information to provide the AI agent 228. For example, the AI agent may be controlling a player that needs to use an item in inventory to overcome some gameplay obstacle. The context-aware model 224 can provide the AI agent 228 with current item inventory information that the AI agent can use to select an item from inventory and overcome the obstacle.

It should be appreciated that the AI agent 228 can be configured for various gameplay tasks. Furthermore, the context information can be extracted for the particular task. For example, the AI agent 228 can be configured for normal gameplay, such as the gameplay of a video game player. The AI agent 228 can also be configured for particular testing tasks (e.g., anomaly testing), such as testing gameplay mechanics (e.g., a physics engine, object interactions, level progressions), stress testing (e.g., performing actions that may cause the game to crash or respond incorrectly), testing gameplay progression (e.g., determining if there are inescapable situations).

For each task, the context extraction unit 220 can be configured for different feature and context extraction and the context-aware model 224 can be configured to provide different context information. For example, if the AI agent 228 is configured for testing object interactions, the context extraction unit 220 can process the video information 210 (e.g., images of objects or other video information), audio information 212 (e.g., sounds indicating object interaction or other video information), and controller information 214 (e.g., inputs for interacting with objects or other controller information) for context information (e.g., spatial coordinates for objects or other context information). Furthermore, if the AI agent 228 is controlling a player that is in a room that includes one or more objects, the context-aware model 224 can provide the context information for each object in the room. The AI agent 228 can then use the information to interact with each object in the room. Additionally, if the AI agent 228 is configured for another task, the context extraction unit 220 can be configured to extract context for that task and the context-aware model 224 can be configured to provide live gameplay context information 226 for that task

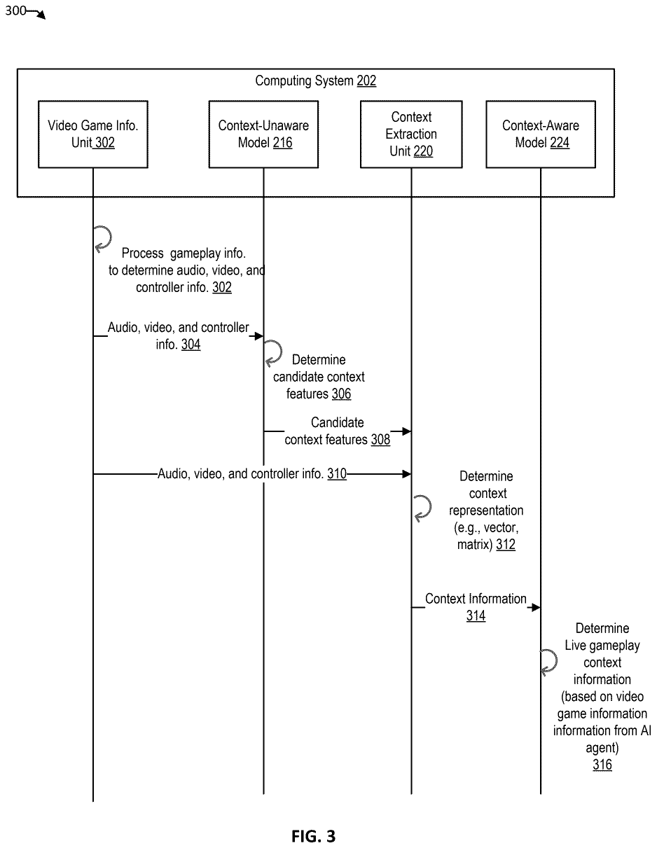

FIG. 3 is an illustration 300 of an example signaling diagram for gameplay data collection, according to one or more embodiments. As illustrated, a computing system 202 can include a video game information unit 302, a context-unaware model 216, a context extraction unit 220 and a context-aware model 224. At 302, the video game information unit 302 can process video game information (e.g. video game information 208) to identify different types of information (e.g., video information 210, audio information 212, and controller information 214) included in the video game information 208. At 304, the video game information unit 302 can transmit one or more of the audio information, the video information, and the controller information to the context-unaware model 216.

At 306, as described above, the context-unaware model 216 can determine candidate features from the video game information. For example, the context-unaware model 216 can use object detection techniques to identify game elements, such as characters, items, and other elements. The context-unaware model 216 can use segmentation techniques to segment the environment into meaningful sections. The context-unaware model 216 can also determine identify elements, such as health bars, scores, countdowns, and other elements. The context-unaware model 216 can identify character positions and movement. The context-unaware model 216 can identify other features that may be helpful to determine context information of the video game application.

At 308, the context-unaware model 216 can transmit the candidate context features to the context extraction unit 220. In addition, the video game information unit 302 can transmit the audio information, the video information, and the controller information to the context extraction unit 220 at 310.

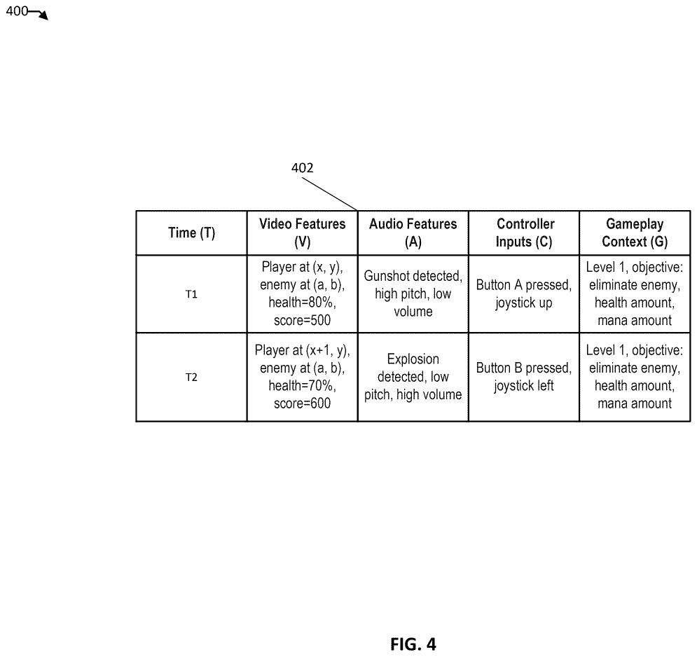

At 312, the context extraction unit 220 can determine a context representation. For example, the context representation can be a matrix that integrates information from the different types of video game information. The matrix can include various information, such as a time index, video features at the time index, audio features at the time index, controller features at the time index, and context information at the time index. An example matrix is provided at FIG. 4.

At 314, the context extraction unit 220 can transmit the context information to the context-aware model 224. The context information can include the context representation and the video game information (e.g., video information, audio information, and controller information).

At 316, the context-aware model 224 can determine live gameplay context information to transmit to an AI agent engaged in a session of a video game application.

FIG. 4 is an illustration 400 of an example context representation, according to one or more embodiments. As illustrated, the matrix 402 can include a time index (e.g., T1 and T2) that can represents a timestamp of a game state. The time index can be used to align the videogame information with the context information. The matrix 402 can further include video features (e.g., video features (V)) that describe information derived from the image frames. For example, image processing techniques can be used to identify various objects (e.g., characters, items, environmental objects) from the image frames. The matrix 402 can include audio features (e.g., audio features (A) that describe features derived from the audio information. The matrix 402 can include controller information (e.g., controller inputs (C)) derived from the controller information. The matrix 402 can also include gameplay context information (e.g., gameplay context (G)). As illustrated, at T1, the video information indicates a player's position and an enemy's position. The audio information indicates that a gunshot is heard. The controller information indicates that button A has been pressed and a joystick has been moved to an up position. Based on the audio, video, and controller request, the context of the information may be that the player is to eliminate the enemy. As illustrated, a similar context can be determined at T2.

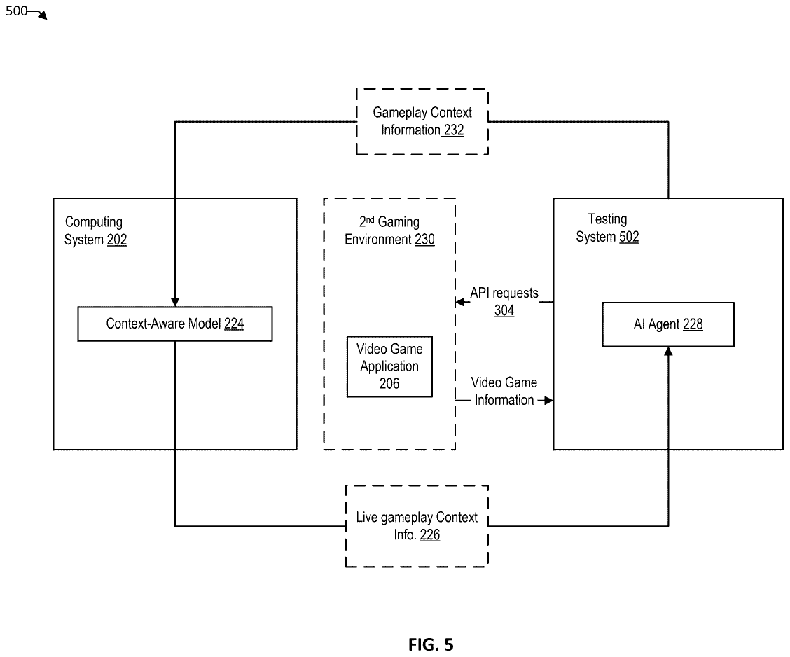

FIG. 5 is an illustration 500 of an example system for using gameplay data by an artificial intelligence (AI) agent, according to one or more embodiments. A computing system 202 can include a context-aware model 224 and be in communication with a testing system 502 that includes an AI agent 228.

The AI agent 228 can be engaged in a gaming session of a video game application 206 in a second game environment 230. For example, the AI agent 228 can transmit an application programming interface (API) request to the video game application 206 to cause some gameplay (e.g., character movement, character choice, or other gameplay). Based on the gameplay, the second game environment 230 can transmit video game information (e.g., audio information, video information, API request information) to the testing system 502. The testing system 502 can transmit gameplay context information 232 back to the context-aware model 224. The gameplay context information 232 can include the video game information and other information. For example, in some embodiments the testing system 502 can be configured to determine context information from the video game information to assist the context-aware model 224.

The context-aware model 224 can use the gameplay context information 232 to determine context information to provide to the AI agent 228. For example, returning to FIG. 4, if the video game information indicates a player's position in proximity to an enemy, and an explosion, the context-aware model 224 can indicate that the AI agent's objective is to eliminate the enemy. The context-aware model 224 can also provide a health amount and a mana amount. Based on the objective to eliminate the enemy, the AI agent 228 can, for example, determine whether to replenish health, mana, or keep fighting the enemy.

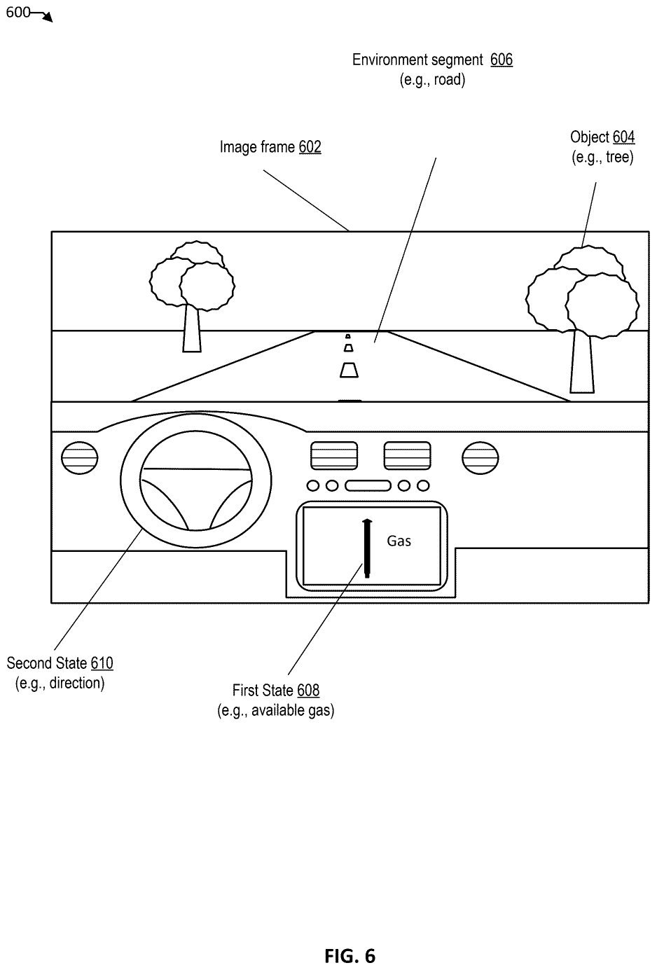

FIGS. 6-8 describe examples of video game information.

FIG. 6 is an illustration 600 of an example video information from gameplay, according to one or more embodiments. As illustrated, an image frame 602 (e.g., video information) of a racing game is shown. Image processing techniques can be used to identify various objects in the image. For example, an object detection technique can be used to identify an object 604 (e.g., tree). Furthermore, segmentation techniques can be used to determine segments of the environment. For example, segmentation techniques can be used to determine a road segment in the environment. Image processing techniques can also be used to determine a first state 608 and a second state 610. For example, the image processing techniques can be used to determine the amount of available gas for the race car. The image processing techniques can also be used to determine the direction the race car is moving.

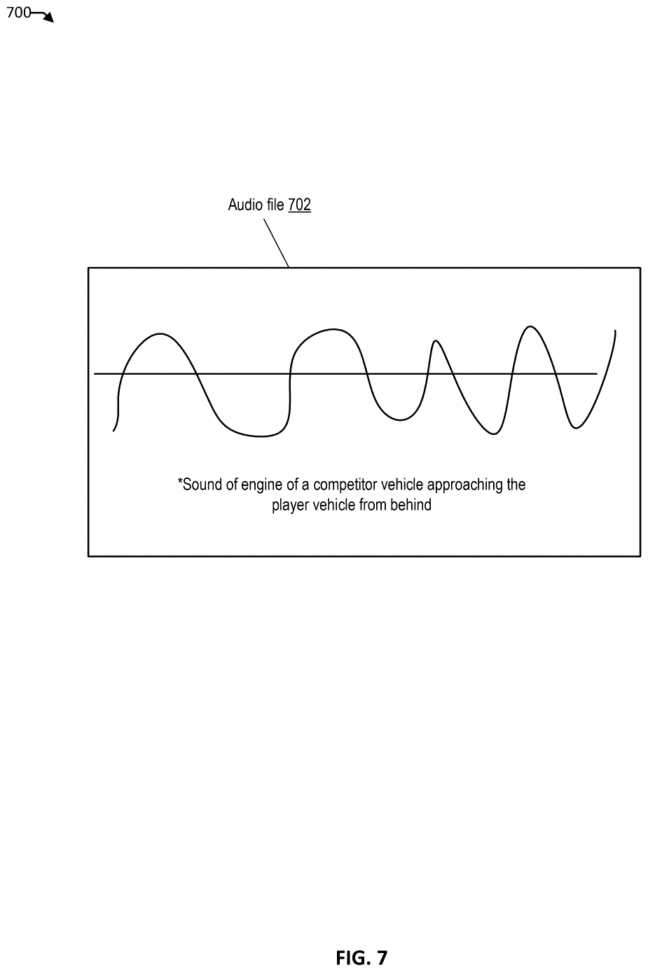

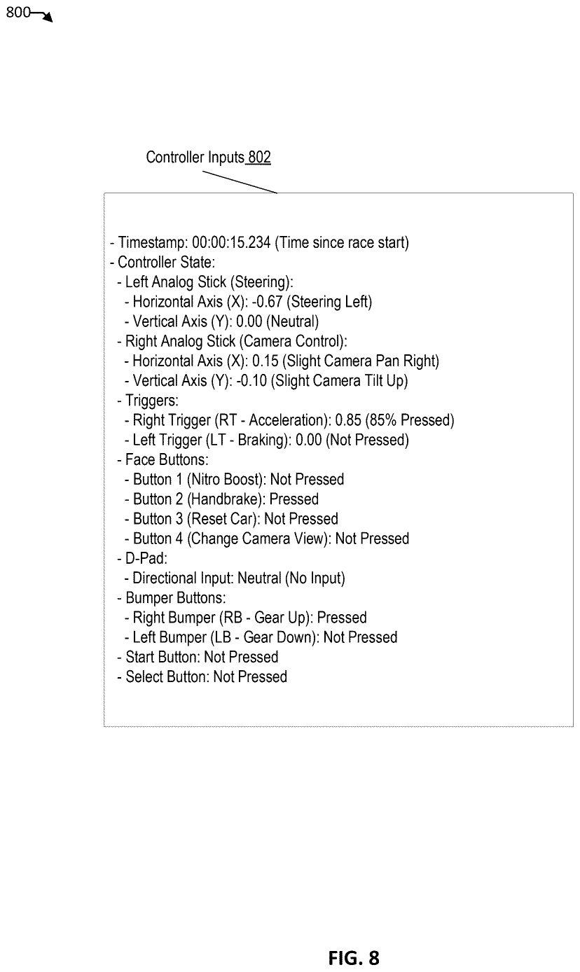

FIG. 7 is an illustration 700 of an example audio information from gameplay, according to one or more embodiments. As illustrated, an audio file 702 (e.g., audio information) of the racing game is shown. Audio processing techniques can be used to identify the sound of a competitor vehicle approaching the race car displayed in FIG. 6. FIG. 8 is an illustration 800 of example controller information from gameplay, according to one or more embodiments. The controller inputs are the inputs that the player (e.g., video game player 108) is providing to a controller (e.g., controller 104) while playing a video game application (e.g., video game application 110).

Based the above described video game information in FIGS. 6, 7, and 8, the context-aware model 224 can provide the AI agent 228 with context information, such as the objective to beat the other race car drivers in the race, an amount of gas that may need to be expended to speed up, or other information. This is an example of context information if the AI agent 228 is configured or gameplay. As indicated above, the AI agent 228 can be configured for various testing tasks. For example, if the AI agent 228 was configured to test the game's physics engine, the context-aware model 224 can provide a location of the tree and the direction of the race car to cause the AI agent 228 to crash into the tree to determine whether the video game application's physics mechanics are accurate.

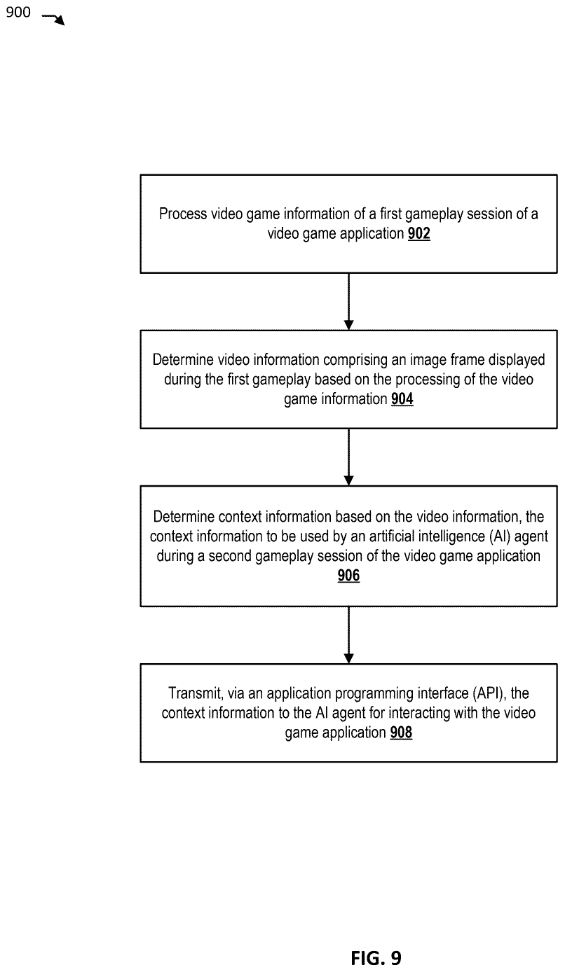

FIG. 9 is an example process 900 for video game information collection, according to one or more embodiments. At 902, the process 900 can include a computing system (e.g., computing system 202) processing video game information (e.g., video game information 208) from a first gameplay session of a video game application (e.g., video game application 206). In some embodiments, the context can include one of a character state (e.g., health, position, or other state), a character inventory, or a character adversary state (e.g., health, position or other state).

In some embodiments, in addition to the video information, the process can include determining audio information corresponding to the image based on processing the video game information, wherein the context information is further based on the audio information. In some embodiments, the process 900 can further include determining controller information corresponding to the image based on processing the video game information, wherein the context information is further based on the controller information.

At 904, the process 900 can include the computing system determining video information (e.g., video information 210 from an image (image frame 602) displayed during the first gameplay session of the video game application based on processing the video game information.

In some embodiments, the process 900 can include providing the video information to a context-unaware model (e.g., context-unaware model 216). The process 900 can further include causing the context-unaware model to generate candidate context information (e.g., candidate context features 218) based on providing the video information to the context-unaware model. The context information can be based on the candidate context information.

In some embodiments, the process 900 can include determining a gameplay task for the AI agent. The process 900 can further include determining a gameplay feature associated with the gameplay task. The process can further include extracting the gameplay feature from the video information, wherein the context information is based on the gameplay feature.

In some embodiments, the process 900 can include generating a context representation (e.g., matrix 402) based on the candidate context information and the video information. The context information can comprise the context representation and the video information.

At 906, the process 900 can include the computing system determining context information (e.g., live gameplay context information 226) based on the video information, the context information to be used by an AI agent (e.g., AI agent 228) during a second gameplay session of the video game application.

In some embodiments, the context information can be provided to a machine learning model (e.g., a multi-modal large language model). The machine learning model can use the context information to determine which information can be provided to the AI agent to use during gameplay. The machine learning model can further access the video game code base on the video game application. The machine learning model can then determine where in the code base to introduce an application programming interface (API) call that is configured to cause the context information to be provided to the AI agent during gameplay. The machine learning model can then generate the API call and update the code base by inserting the API call into the code base. In these instances, as the AI agent is playing the video game application, the API call can cause the context information to be provided to the AI agent. The AI agent can use the context information to influence its gameplay decision making.

In some embodiments, the process can include providing the candidate context information to a context-aware model (e.g., context-aware model 224). The process 900 can further include causing the context-aware model to generate the context information based on providing the candidate context information.

At 908, the process 900 can include the computing system transmitting, via an API, the context information to the AI agent for interacting with the video game application.

In some embodiments, the context information is based on a first gameplay feature. The process 900 can further include processing feedback from the AI agent based on the second gameplay session of the video game application. The process 900 can further include determining a second gameplay feature based on the feedback. The process 900 can further include determining second context information based on the first context information and the second gameplay feature. The process 900 can further include transmitting the second context information to the AI agent.

In some embodiments, the process 900 can include determining a gameplay action (e.g., running into a wall to test video game application testing for an anomaly, or other action) to be performed by a video game character to be controlled by the AI agent during the second gameplay session of the video game application. The process 900 can further include determining a gameplay feature associated with the gameplay action. The process 900 can further include extracting the gameplay feature from the video information, wherein the context information is based on the gameplay feature.

In some embodiments, the process 900 can include processing feedback from the AI agent based on the second gameplay session of the video game application. The process 900 can further include updating a video game codebase based on the feedback, wherein the video game application is based on the video game codebase. For example, the feedback may indicate a error in the video game codebase, and the computing system can fix the coding error in the video game codebase.

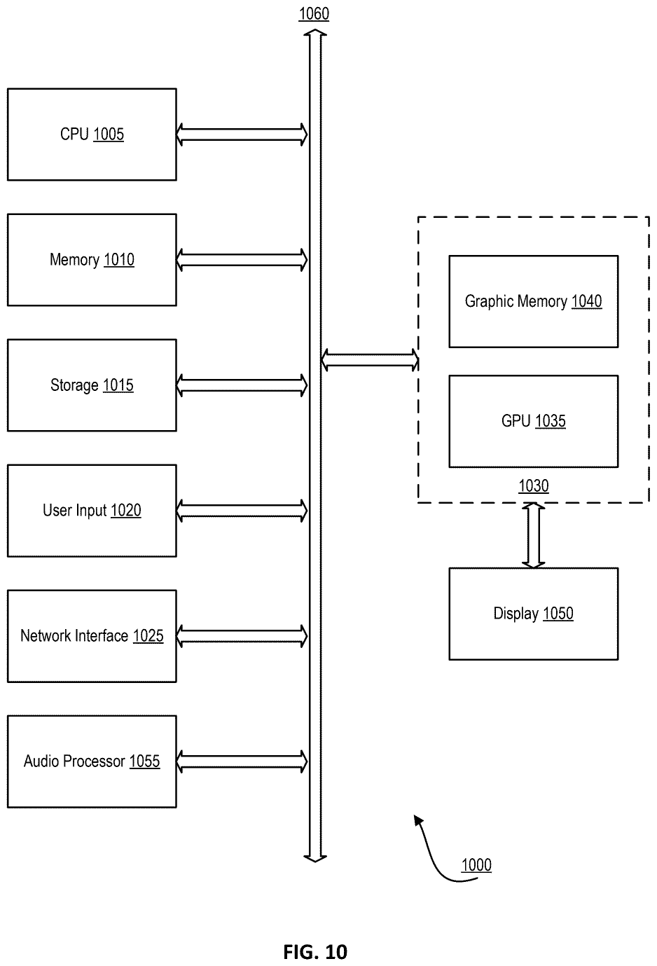

FIG. 10 illustrates an example of a hardware system suitable for implementing a computer system, according to embodiments of the present disclosure. The computer system 1000 represents, for example, a video game system, a backend set of servers, or other types of a computer system. The computer system 1000 includes a central processing unit (CPU) 1005 for running software applications and optionally an operating system. The CPU 1005 may be made up of one or more homogeneous or heterogeneous processing cores. Memory 1010 stores applications and data for use by the CPU 1005. Storage 1015 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1020 communicate user inputs from one or more users to the computer system 1000, examples of which may include keyboards, mice, joysticks, touch pads, touch screens, still or video cameras, and/or microphones. Network interface 1025 allows the computer system 1000 to communicate with other computer systems via an electronic communications network, and may include wired or wireless communication over local area networks and wide area networks such as the Internet. An audio processor 1055 is adapted to generate analog or digital audio output from instructions and/or data provided by the CPU 1005, memory 1010, and/or storage 1015. The components of computer system 1000, including the CPU 1005, memory 1010, data storage 1015, user input devices 1020, network interface 1025, and audio processor 1055 are connected via one or more data buses 1060.

A graphics subsystem 1030 is further connected with the data bus 1060 and the components of the computer system 1000. The graphics subsystem 1030 includes a graphics processing unit (GPU) 1035 and graphics memory 1040. The graphics memory 1040 includes a display memory (e.g., a frame buffer) used for storing pixel data for each pixel of an output image. The graphics memory 1040 can be integrated in the same device as the GPU 1035, connected as a separate device with the GPU 1035, and/or implemented within the memory 1010. Pixel data can be provided to the graphics memory 1040 directly from the CPU 1005. Alternatively, the CPU 1005 provides the GPU 1035 with data and/or instructions defining the desired output images, from which the GPU 1035 generates the pixel data of one or more output images. The data and/or instructions defining the desired output images can be stored in the memory 1010 and/or graphics memory 1040. In an embodiment, the GPU 1035 includes 3D rendering capabilities for generating pixel data for output images from instructions and data defining the geometry, lighting, shading, texturing, motion, and/or camera parameters for a scene. The GPU 1035 can further include one or more programmable execution units capable of executing shader programs.

The graphics subsystem 1030 periodically outputs pixel data for an image from the graphics memory 1040 to be displayed on the display device 1050. The display device 1050 can be any device capable of displaying visual information in response to a signal from the computer system 1000, including CRT, LCD, plasma, and OLED displays. The computer system 1000 can provide the display device 1050 with an analog or digital signal.

In accordance with various embodiments, the CPU 1005 is one or more general-purpose microprocessors having one or more processing cores. Further embodiments can be implemented using one or more CPUs 1005 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising:
processing video game information of a first gameplay session of a video game application;
determining video information comprising an image frame displayed during the first gameplay based on the processing of the video game information;
determining context information based on the video information, the context information to be used by an artificial intelligence (AI) agent during a second gameplay session of the video game application; and
transmitting, via an application programming interface (API), the context information to the AI agent for interacting with the video game application.

2. The method of claim 1, wherein the method further comprises:
providing the video information to a context-unaware model; and
causing the context-unaware model to generate candidate context information based on providing the video information to the context-unaware model, wherein the context information is based on the candidate context information.

3. The method of claim 2, wherein the method further comprises:
providing the candidate context information to a context-aware model; and
causing the context-aware model to generate the context information based on providing the candidate context information.

4. The method of claim 2, wherein determining the context information comprises:
generating a context representation based on the candidate context information and the video information, wherein the context information comprises the context representation and the video information.

5. The method of claim 1, wherein the method further comprises;
determining audio information corresponding to the image frame based on processing the video game information, wherein the context information is further based on the audio information.

6. The method of claim 1, wherein the method further comprises:
determining controller information corresponding to the image frame based on processing the video game information, wherein the context information is further based on the controller information.

7. The method of claim 1, wherein the method further comprises:
determining a gameplay task for the AI agent;
determining a gameplay feature associated with the gameplay task; and
extracting the gameplay feature from the video information, wherein the context information is based on the gameplay feature.

8. The method of claim 1, wherein the context information is based on a first gameplay feature, and wherein the method further comprises:
processing feedback from the AI agent based on the second gameplay session of the video game application;
determining a second gameplay feature based on the feedback;
determining second context information based on the first context information and the second gameplay feature; and
transmitting the second context information to the AI agent.

9. The method of claim 1, wherein the method further comprises:
determining a gameplay action to be performed by a video game character to be controlled by the AI agent during the second gameplay session of the video game application;
determining a gameplay feature associated with the gameplay action; and
extracting the gameplay feature from the video information, wherein the context information is based on the gameplay feature.

10. The method of claim 1, wherein the method further comprises:
determining audio information corresponding to the video information based on processing the video game information;
determining controller information corresponding to the video information based on processing the video game information;
determining a context of the video information based on the audio information and the controller information, wherein the context information is based on the context.

11. The method of claim 1, wherein the method further comprises:
processing feedback from the AI agent based on the second gameplay session of the video game application; and
updating a video game codebase based on the feedback, wherein the video game application is based on the video game codebase.

12. The method of claim 1, wherein the context information comprises one of a character state, a character inventory, or a character adversary.

13. A computing system comprising:
one or more processors; and
one or more computer readable media comprising a sequence of instructions that, when executed, cause the computing system to:
process video game information of a first gameplay session of a video game application;
determine video information comprising an image frame displayed during the first gameplay based on the processing of the video game information;
determine context information based on the video information, the context information to be used by an artificial intelligence (AI) agent during a second gameplay session of the video game application; and
transmit, via an application programming interface (API), the context information to the AI agent for interacting with the video game application.

14. The computing system of claim 13, wherein the sequence of instructions that, when executed, further cause the computing system to:
provide the video information to a context-unaware model; and
cause the context-unaware model to generate candidate context information based on providing the video information to the context-unaware model, wherein the context information is based on the candidate context information.

15. The computing system of claim 14, wherein the sequence of instructions that, when executed, further cause the computing system to:
provide the candidate context information to a context-aware model; and causing the context-aware model to generate the context information based on providing the candidate context information.

16. The computing system of claim 14, wherein determining the context information comprises:
generating a context representation based on the candidate context information and the video information, wherein the context information comprises the context representation and the video information.

17. The computing system of claim 13, wherein the sequence of instructions that, when executed, further cause the computing system to:
determine audio information corresponding to the image frame based on processing the video game information, wherein the context information is further based on the audio information.

18. One or more non-transitory, computer-readable media comprising a sequence of instructions that, when executed, cause a computing system to:
process video game information of a first gameplay session of a video game application;
determine video information comprising an image frame displayed during the first gameplay based on the processing of the video game information;
determine context information based on the video information, the context information to be used by an artificial intelligence (AI) agent during a second gameplay session of the video game application; and
transmit, via an application programming interface (API), the context information to the AI agent for interacting with the video game application.

19. The one or more non-transitory, computer-readable media of claim 18, wherein the sequence of instructions that, when executed, further cause the computing system to:
provide the video information to a context-unaware model; and
cause the context-unaware model to generate candidate context information based on providing the video information to a context-unaware model, wherein the context information is based on the candidate context information.

20. The one or more non-transitory, computer-readable media of claim 19, wherein the sequence of instructions that, when executed, further cause the computing system to:
provide the candidate context information to a context-aware model; and
causing the context-aware model to generate the context information based on providing the candidate context information.
